(19) United States
(12) Patent Application Publication
(10) Pub. No.: US 2020/0250414 A1
(43) Pub. Date: Aug. 6, 2020

(54) ELECTRONIC DEVICE AND HANDWRITING BOARD SYSTEM

(71) Applicant: Acer Incorporated, New Taipei City (TW)

(72) Inventor: Chueh-Pin Ko, New Taipei City (TW)

(73) Assignee: Acer Incorporated, New Taipei City (TW)

(21) Appl. No.: 16/421,479

(22) Filed: May 24, 2019

(30) Foreign Application Priority Data
Feb. 1, 2019 (TW) 108104131

(51) Int. Cl. G06K 9/00

(52) U.S. Cl. CPC G06K 9/00402; G06K 9/00483

(57) ABSTRACT

An electronic device having a communication unit, a storage unit, an image obtaining unit and a processing unit is provided. The input unit receives a plurality of handwriting files. The storage stores a plurality of original document files. The image obtaining unit obtains a document image. The handwriting files and the original document files include a document handwriting file and an original document file corresponding to the document image respectively. The processing unit is connected to the communication unit, the storage unit and the image obtaining unit and recognizes a content of the document image to integrate the document image, the document handwriting file and the original document file into a document grouping file according to the content of the document image. A handwriting board system is also provided.

### CROSS-REFERENCE TO RELATED APPLICATION

This application claims the priority benefit of Taiwan application serial no. 108104131, filed on Feb. 1, 2019. The entirety of the above-mentioned patent application is hereby incorporated by reference herein and made a part of this specification.

### BACKGROUND OF THE INVENTION

### Technical Field

The disclosure relates to a grouping technology and, more particularly to an electronic device and handwriting board system using the grouping technology.

### Description of Related Art

With the trend of the digital era, various types of documents have been stored in digital format, which is not only environmentally friendly but also has the advantage of convenient management. However, for documents that are highly sensitive, such as legal documents, most of them will still be signed on paper, and at the same time paper and scanned copies are retained. Therefore, in the handwriting board technology, a stylus with ink and a touch panel for the stylus are developed. In this way, when the user is writing, not only written documents are retained, but handwriting is also recorded, whereby the digital file of the document is stored. Although this technology can alleviate the cumbersome process of digitizing a document by the user, the handwriting board can only provide a handwriting record, but cannot create a connection between the handwriting and the paper. In particular, if the user is writing on a document that already contains other information, no connection can occur between the handwriting and the document.

### SUMMARY OF THE INVENTION

The disclosure provides an electronic device and a handwriting board system for grouping document images, handwriting files, and original files through automatic recognition technology.

According to an embodiment of the disclosure, the electronic device includes a communication unit, a storage unit, an image obtaining unit and a processing unit. The communication unit receives a handwriting file. The storage unit stores an original file. The image obtaining unit obtains a document image, and the handwriting file and the original file include a document handwriting file that corresponds to the document image and an original document file respectively. The processing unit is connected to the communication unit, the storage unit and the image obtaining unit, and recognizes the content of the document image so as to integrate the document image, the document handwriting file and the original document file into the document grouping file according to the content of the document image.

According to an embodiment of the disclosure, the handwriting board system has a handwriting board and an electronic device. The handwriting board detects handwriting to generate a handwriting file. The electronic device is connected to the handwriting board, and receives the handwriting file from the handwriting board. The electronic device further stores the original file. The electronic device obtains a document image, and the handwriting file and the original file include a document handwriting file corresponding to the document image and an original document file respectively. The electronic device also recognizes the content of the document image and integrates the document image, the document handwriting file and the original document file into the document grouping file according to the content of the document image.

In view of the above, the electronic device and the handwriting board system of the disclosure allow the document image, the document handwriting file and the original document file to be integrated into the document grouping files that are related to each other, thereby improving the efficiency of managing documents.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a handwriting board system according to an embodiment of the disclosure.

FIG. 2 is a flow chart showing a method of grouping files according to an embodiment of the disclosure.

FIGS. 3A and 3B are flow charts showing the details of the method of grouping files according to an embodiment of the disclosure.

FIGS. 4A and 4B are flow charts showing the details of the method of grouping files according to an embodiment of the disclosure.

FIG. 5 is a flow chart showing the details of the method of grouping files according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

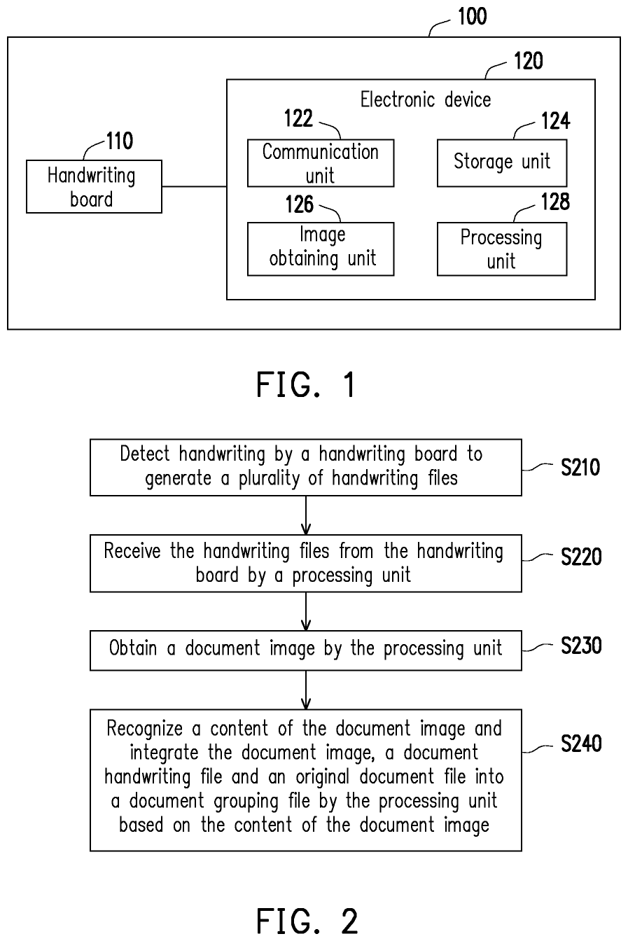

FIG. 1 is a schematic diagram of a handwriting board system according to an embodiment of the disclosure. Referring to FIG. 1, a handwriting board system 100 includes a handwriting board 110 and an electronic device 120.

The handwriting board 110 is used to detect handwriting to generate a handwriting file according to the handwriting. In an embodiment of the disclosure, the handwriting is the trace of a stylus on the handwriting board 110. Specifically, the stylus has functions of both digital writing and physical writing at the same time, that is, the stylus has ink to allow the user to write directly on the paper. When the user places the paper on the handwriting board 110 for writing, the handwriting board 110 can detect the trace and area of the stylus through changes in electrical property. In an embodiment of the disclosure, the type of stylus is, for example, but not limited to, an electromagnetic active stylus or a capacitive stylus. Any stylus that is compatible with the handwriting board 110 can be used in the disclosure. The handwriting board 110 is, for example, but not limited to, a force sensitive resistor, a capacitive pressure sensor, an inductive pressure sensor, a thin-film pressure sensor, all of which use electro-magnetic resonance (EMR) technology, or the like.

The electronic device 120 is connected to the handwriting board 110 to receive a handwriting file from the handwriting board 110. In an embodiment of the disclosure, the electronic device 120 includes a communication unit 122 to be communicatively connected to the handwriting board 110. For example, the communication unit 122 can be connected by wires, for example, by physical fibers, telecommunication cables, and the like. Alternatively, the electronic device 120 and the handwriting board 110 may be connected to each other via a wireless network, for example, via Bluetooth, WiFi, the Internet, and the like, but the disclosure is not limited thereto. The communication unit can be implemented by any communication chip used in wired or wireless communication, but the disclosure is not limited thereto.

In an embodiment of the disclosure, the electronic device 120 further includes a storage unit 124 storing at least one original file. The original file is any blank file, for example, but not limited to, a legal contract document, an inventory sheet, an audit form, and the like. The storage unit 124 is, for example, any type of fixed or movable random access memory (RAM), read-only memory (ROM), flash memory, a hard disk drive (HDD), a solid state drive (SSD), or the like or a combination thereof.

In an embodiment of the disclosure, the electronic device 120 further includes an image obtaining unit 126 to capture or scan images of a file, whereby the content of a document image is obtained. The image obtaining unit 126 is, for example, a camera built in the electronic device 120 or an external camera or camera electrically connected to the electronic device 120. However, the disclosure is not limited thereto.

The electronic device 120 also has a processing unit 128 to provide basic computing and functions. The processing unit is, for example, but not limited to, a central processing unit (CPU), a microprocessor unit (MPU) or micro control unit (MCU), etc.

In an embodiment of the disclosure, the electronic device 120 is, for example, a mobile phone, a tablet computer, a personal computer, or a notebook computer, but the disclosure is not limited thereto. Any device having the above components and functions can serve as an electronic device.

FIG. 2 is a flow chart showing a method grouping files according to an embodiment of the disclosure. The method of grouping files is applicable to at least the handwriting board system 100 of FIG. 1, but the disclosure is not limited thereto. The process of performing the method of grouping files will be described below with reference to the handwriting board system 100 of FIG. 1.

In step S210, the handwriting board 110 detects the handwriting to generate at least one handwriting file. In detail, the handwriting board 110 detects the handwriting depending on changes in electrical property caused by the stylus contacting the handwriting board 110. Moreover, the handwriting board 110 stores the detected handwriting as a handwriting file.

In step S220, the processing unit 128 receives the handwriting file from the handwriting board 110. Further, in step S230, processing unit 128 obtains a document image. The document image is a digital image created by using a paper file written by the user. For example, in the embodiment, the processing unit 128 captures images of the paper file by the image obtaining unit 126, thereby creating a document image. In other embodiments of the disclosure, the processing unit 128 may also input the document image into an electronic device through various types of input units such as a USB port. Alternatively, in another embodiment, the electronic device 120 may also receive the document image by the communication unit 122. However, the disclosure is not limited thereto.

In step S240, the electronic device 120 recognizes the content of the document image and integrates the document image, a document handwriting file, and an original document file into a document grouping file according to the content of the document image. In detail, since the document image is a digital image created by using a paper file written by the user, and therefore the document image shows images corresponding to the handwriting and images corresponding to the original file. Moreover, the original document file and the handwriting file in the storage unit 124 includes a document handwriting file and an original document file corresponding to the document image. Therefore, the processing unit 128 can perform image recognition on the document image and associate the document image with the document handwriting file and the original file that correspond to the document image according to the content of the document image (for example, handwriting, something other than handwriting, or other features) and further allow for integration of a document grouping file. That is, the document grouping file is a relevant combination of the document image, the document handwriting file and the original document file. In this way, the document image, the document handwriting file and the original document file are no longer simply stored, but the connection between the document image, the document handwriting file and the original document file is enhanced by the document grouping file, thereby improving the efficiency of managing documents.

It should be noted that the document image is not limited to a complete paper document. In an embodiment of the disclosure, the document image may be a part of the paper document and corresponds to the parts of the handwriting file and the original file. The processing unit 128 can still use the method of grouping files of FIG. 2 to compare and group some of the document images, the handwriting files and the original files, but the disclosure is not limited thereto.

It should be noted that in the embodiment of FIG. 2, there is no limit on the timing of the communicative connection between the handwriting board 110 and the electronic device 120. For example, the handwriting board 110 and the electronic device 120 can maintain a communicative connection at all times. That is, prior to step S210, the handwriting board 110 has been in communicative connection with the electronic device 120. Alternatively, the communicative connection between the handwriting board 110 and the electronic device 120 is initiated in step S220.

In addition, in another embodiment of the disclosure, the sequence of steps S220 and S230 may be exchanged. That is, the electronic device 120 can obtain the document image, and is then communicatively connected to the handwriting board 110. In another embodiment of the disclosure, the electronic device 120 automatically initiates the connection between the communication unit 122 and the handwriting board 110 when the image obtaining unit 126 obtains the document image. Alternatively, the electronic device 120 supports the timing of each of the aforementioned connections simultaneously. That is, the electronic device 120 just need to have the ability to be connected to the handwriting board 110 to receive the handwriting file, but the disclosure is not limited thereto. In particular, in the foregoing various embodiments, the different time points of the connection between the electronic device 120 and the handwriting board 110 can all be simultaneously supported by the electronic device 120, but the disclosure is not limited thereto.

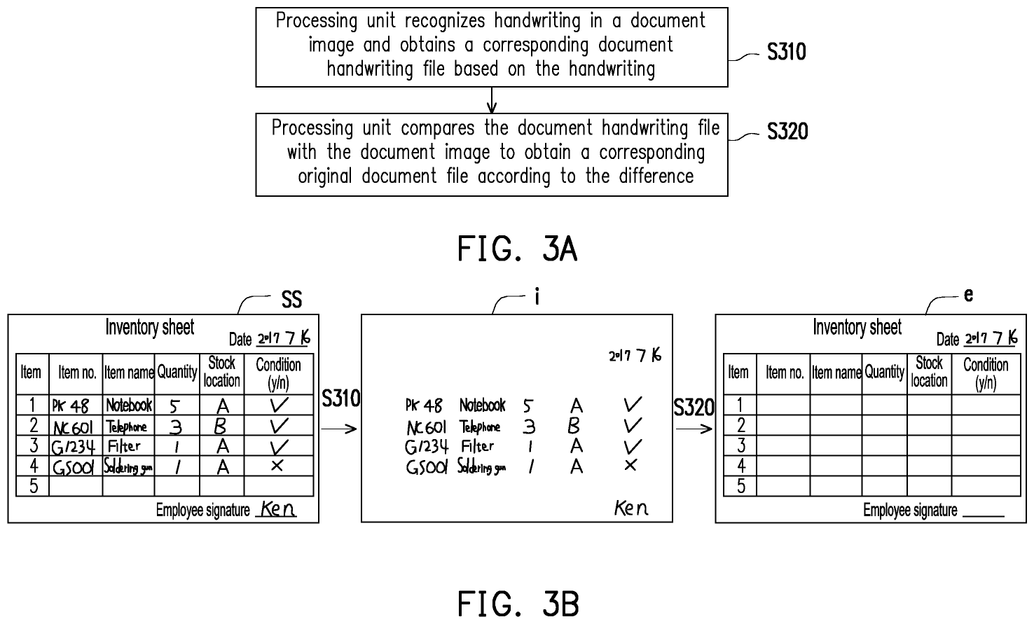

The following are the details of how the electronic device 120 recognizes the content of the document image and integrates the document image, the document handwriting file and the original document file into the document grouping file in accordance with the content of the document image in different embodiments, wherein the details are presented using FIGS. 3A to 5.

FIGS. 3A and 3B are flow charts showing the details of the method of grouping files according to an embodiment of the disclosure. Referring to FIG. 3A and FIG. 3B simultaneously, in the present embodiment, a document image SS is an inventory sheet recording the item number, item name, quantities of items, stock location, condition of items and the user name written by the user.

In step S310, the processing unit 128 recognizes the handwriting in the document image and obtains the corresponding document handwriting file according to the handwriting. Specifically, since each person has different positions of writing, strength, sequence of stroke, ways of applying force, and shapes of letters when writing, the processing unit 128 recognizes the handwriting in the document image according to handwriting features in the document image to identify a handwriting image in the document image belonging to the handwriting. In an embodiment of the disclosure, the handwriting features include, for example, at least one of an ink trace, an ink vector, a position of handwriting, the distribution of handwriting, the color of handwriting, and the thickness of handwriting.

Since the handwriting image is a result of image analysis of the document image by the processing unit 128, in this embodiment, the processing unit 128 further compares the handwriting file with the handwriting image to obtain a document handwriting file i corresponding to the document image SS. Moreover, in the present embodiment, there are potential recognition errors when image recognition is performed on the handwriting. Therefore, in the process of comparing the handwriting file with the handwriting image, the processing unit 128 determines that the handwriting file is the document handwriting file i corresponding to the document image SS when similarity between the handwriting image and the handwriting file is above a similar threshold (for example, but not limited to, 80%).

Moreover, in order to improve the efficiency of handwriting recognition, in an embodiment of the disclosure, the processing unit 128 can compare the handwriting file and the handwriting image through single area comparison (single consistency), partial area comparison (partial consistency) and complete area comparison (100% consistency) to obtain a document handwriting file corresponding to the handwriting image. The single area comparison works by comparing a specific block in the handwriting image with a specific block in the handwriting file. For example, the processing unit 128 can be set to compare the upper left corners of the handwriting file and the handwriting image. If the upper left corners of the handwriting file and the handwriting image are consistent or the similarity between the upper left corners of the handwriting file and the handwriting image is above the similar threshold, it is determined that the handwriting file corresponds to the handwriting image. In particular, if the handwriting board system 100 is used to manage a record of reports, such as an inventory sheet, the processing unit 120 can be set to recognize the block to which the item number belongs. That is, if the similarity in the content of the block of the corresponding item number between the handwriting file and the handwriting image is above the similar threshold, the processing unit 120 determines that the handwriting file corresponds to the handwriting image, and that the handwriting file is a document handwriting file corresponding to the handwriting image.

Similarly, the partial area comparison works by comparing multiple specific blocks in the handwriting image with multiple specific blocks in the handwriting file. Further to the above, the processing unit 120 can also be set to recognize the item number, date and signed block. That is, if the similarity in the contents of the corresponding item number, date and signed block between the handwriting file and the handwriting image is above the similar threshold, the processing unit 120 determines that the handwriting file corresponds to the handwriting image, and that the handwriting file is a document handwriting file corresponding to the handwriting image.

The complete area comparison works by comparing all blocks in the handwriting image with all blocks in the handwriting file. That is, when the entire handwriting file and the entire handwriting image are consistent or similarity is above the similarity threshold, the processing unit 120 determines that the handwriting file corresponds to the handwriting image. In practice, the user or the developer can adjust the method of comparison according to needs, thereby striking a balance between recognition accuracy and recognition efficiency.

It should be noted that in an embodiment of the disclosure, the processing unit 128 can further determine whether the handwriting file is the document handwriting file i corresponding to the document image SS through other information.

In detail, in an embodiment of the disclosure, the document image and the handwriting file have corresponding file features respectively. In an embodiment of the disclosure, the file features are, for example, at least one of a user's name (i.e., the name of a person who creates the file), a position where the file is created (e.g., obtaining GPS of a document image and a handwriting file by making tags by hand or through automatic recording) and the time when the file is created. Therefore, the processing unit 128 can further compare at least one of the user name, the position where the file is created and the time when the file is created of the document image and the handwriting file to obtain the document handwriting file corresponding to the document image.

In step S320, the processing unit 128 compares the document handwriting file i with the document image SS to obtain a corresponding original document file e according to the difference. When the document handwriting file i is extracted, the rest of the document image SS is an original document image that is not written. Therefore, the processing unit 128 compares the original document file with the original file to find out the original document file e that is suitable for the document image.

In this way, the processing unit 128 recognizes the document handwriting file i and the original document file e from the document image SS and integrates the document image SS, the document handwriting file i, and the original document file e into a document grouping file.

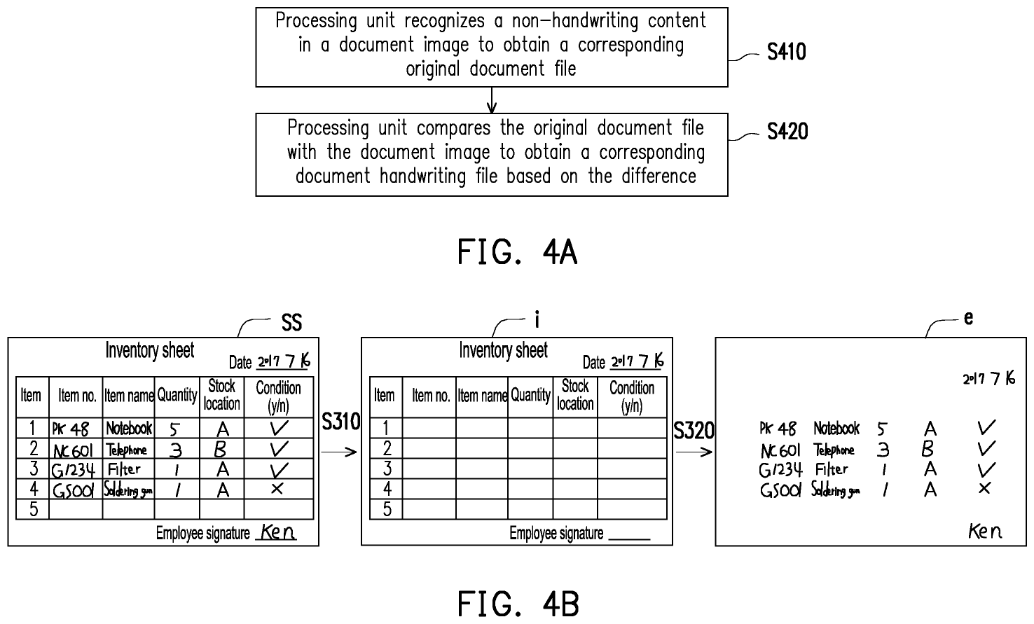

FIGS. 4A and 4B are flowcharts showing the details of the method of grouping files according to an embodiment of the disclosure. Referring to FIGS. 4A and 4B at the same time, FIGS. 4A and 4B show that the same document image SS is taken as an example for illustrative purposes, but the process of handling the document image SS is slightly different.

In step S410, the processing unit 128 recognizes a content of the document image that is related to the handwriting to obtain the corresponding original document file e. Similar to step S310, the processing unit 128 has the ability to recognize handwriting, and in contrast, has the ability to recognize a non-handwriting content. Therefore, the processing unit 128 can obtain an original file image by capturing the non-handwriting content or removing the content related to the handwriting from the document image SS.

The processing unit 128 compares the original file image with the original file to obtain the corresponding original document file e. Similar to what is mentioned before, in the process of recognizing and analyzing the document image SS and the original file image, there is a possibility of recognition errors. Therefore, the processing unit 128 determines that the original file is the original document file e corresponding to the document image SS when it is determined that the similarity between the original document file and the original file is above the similar threshold (for example, but not limited to, 80%).

It should be noted that, in an embodiment of the disclosure, if multiple original documents similar to the original file image are found, the processing unit 128 further determines which files have recently been printed by the electronic device 120 to sort out possible original files, which increases the possibility of successful comparison.

In step S420, the processing unit 128 compares the original document file e and the document image SS to obtain the corresponding document handwriting file i according to the difference. Similar to what is mentioned before, when the original document file e is extracted, the rest of the document image SS is a handwriting image corresponding to the handwriting. Therefore, the processing unit 128 compares the handwriting image with the handwriting file to find out the document handwriting file i that is suitable for the document image SS.

In this way, the processing unit 128 recognizes the document handwriting file i and the original document file e from the document image SS and integrates the document image SS, the document handwriting file i and the original document file e into a document grouping file.

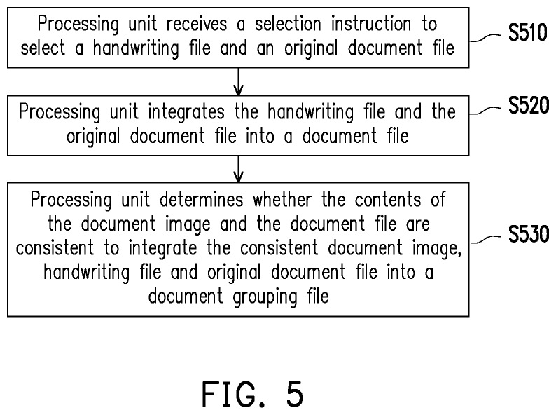

FIG. 5 is a flowchart showing the details of the method of grouping files according to an embodiment of the disclosure. Referring to FIG. 5, in step S510, the processing unit 128 further receives a selection instruction to select a document handwriting file and an original document file. That is, in this embodiment, the user can directly select the file to be grouped by the electronic device 120.

In step S520, the processing unit 128 integrates the handwriting file and the original document file into a document file. The document image is a digital image generated by using a paper file written by the user. Therefore, when the document handwriting file and the original document file of the user are integrated into a document file, the document file should be the same as the paper file written by the user and the document image.

In step S530, the processing unit 128 determines whether the contents of the document image and the document file are consistent so as to integrate the consistent document image, document handwriting file and original document file into the document grouping file. Since the document file should be identical to the paper file written by the user and the document image, the electronic device 120 further compares the document file with the document image to determine whether the contents of the document file and the document image are consistent. If the contents are consistent, it means that the document handwriting file and the original document file used to form a document file correspond to the document image. Therefore, the electronic device 120 can integrate the consistent document image, document handwriting file and the original document file into the document grouping file.

It should be noted that the above-mentioned embodiments in the FIGS. 3A to 5 can also apply to the same handwriting board system 100 at the same time to provide the user with various ways of grouping files, but the disclosure is not limited thereto.

Moreover, in an embodiment of the disclosure, if the document handwriting file belongs to a handwriting file in a file group, and the file group has a plurality of handwriting files, at this time, the processing unit 128 integrates the document image, the original document file and the file group into the document grouping file according to the document handwriting file.

In detail, in the case of an embodiment of the disclosure, the user continues to write on the same document. For example, when carrying out the annual inventory count, the user will write continuously on the same blank inventory sheet. At this time, the files written by the user are all the same original document file, but the handwriting board 110 generates a plurality of handwriting files. To alleviate the burden of capturing file images on the user in this situation, according to an embodiment of the disclosure, the processing unit 128 further determines whether the document handwriting file belongs to a file group after integrating the document image, the document handwriting file and the original document file into the document grouping file.

The file group has a handwriting file within a limited range. For example, the limited range is determined by a period of time (for example, one day, one hour, etc.) or and the interval between two documents that does not exceed the waiting threshold (for example, five minutes, one hour, etc.). Alternatively, the processing unit 128 may logically or physically group files according to the position of operation, the name of the user and the like. In an embodiment of the disclosure, the processing unit 128 inquires whether the handwriting file belongs to the same file group whenever the user completes a handwriting file. In an embodiment of the disclosure, the user can also add a handwriting file outside the limited range by hand, and the processing unit 128 can further add a handwriting file within the limited range corresponding to the previously added handwriting file to the same file group.

In an embodiment of the disclosure, the file group includes a plurality of handwriting files for the same original document file. The processing unit 128 can also compare the handwriting files with the handwriting images by the single area comparison or partial area comparison to identify whether the handwriting files correspond to the handwriting images. Moreover, after finding out a set of a corresponding handwriting file and handwriting image, the processing unit 128 further forms a file group according to other handwriting files within the limited range corresponding to the handwriting file. Moreover, the processing unit 128 also integrates the document image, the original document file and the file group into the document grouping file. Specifically, the electronic device 120 confirms the document handwriting file corresponding to the handwriting image by the single area comparison or partial area comparison, and determines what the document handwriting file is ranked in the file group, combine each of the handwriting file and the original document file in the file group to generate a plurality of document files and group the document files in order as a document grouping file. In this way, it is possible to reduce the frequency of obtaining the document image and simplify the steps of the method of grouping files. The single area comparison or partial area comparison has been detailed above, and will not be described again here.

For example, the user has been writing for an hour, and therefore ten handwriting files are generated. By the single area comparison or partial area comparison, the processing unit 128 determines that the document handwriting file matching the handwriting image is ranked seventh in the ten handwriting files. Therefore, the processing unit 128 combines the first handwriting file and the original document file, the second handwriting file and the original document file until the tenth handwriting file and the original document file in order of the handwriting file to generate a corresponding document file. Moreover, the processing unit 128 relates the handwriting file to the corresponding document file to generate the document grouping file. Therefore, the user need not take a picture of each written document, thereby avoiding carrying out cumbersome operations and effectively improving the efficiency of grouping files.

In addition, in an embodiment of the disclosure, the file group includes a plurality of handwriting files of an original document file with multiple pages such as a legal contract. At this time, similar to what is mentioned before, the user can also take a picture of one of the plurality of pages of the document, and the processing unit 128 confirms the document handwriting file corresponding to the handwriting image by the single area comparison or partial area comparison, and determines the rank of the document handwriting file within a limited range (that is, what the document handwriting file is ranked). For example, the original document file selected by the user has three pages, and the processing unit 128 receives three handwriting files. The user takes a picture of one of the pages, and the picture is processed before a corresponding handwriting image is generated. In this way, the processing unit 128 matches the handwriting image to the three handwriting files by the single area comparison or partial area comparison to determine what the document handwriting file corresponding to the handwriting image is ranked, for example, third. Therefore, the processing unit 128 combines the first handwriting file and the first page of the original document file and combines the second handwriting file and the second page of the original document file in order of the document handwriting file to generate a corresponding document file. Moreover, the processing unit 128 integrates the handwriting file with the corresponding document file to generate the document grouping file. In this way, in multi-page mode, the user need not take a picture of each written document, thereby avoiding carrying out cumbersome operations and effectively improving the efficiency of grouping files.

It should be noted that, in an embodiment of the disclosure, when receiving plenty of handwriting, the handwriting board 110 distinguishes whether the handwriting belongs to a handwriting file according to the writing time, the paging instruction, or whether the position of recognizing the handwriting corresponds to the position of completing the document. For example, if the handwriting board 110 determines that plenty of handwritings are detected at the same interval (for example, but not limited to, within five minutes), it is determined that the handwriting belongs to the same handwriting file. Alternatively, the handwriting board 110 determines that the interval between two sets of handwriting is less than a designated interval (for example, but not limited to, within one minute), and the two sets of handwriting belong to the same handwriting file. Alternatively, if the handwriting board 110 receives the paging instruction (for example, completion of files, instructions to change pages, and the like), it is determined that the new handwriting file is opened according to the paging instruction. Furthermore, if the handwriting board 110 determines that the position of the handwriting corresponds to the position of completing the document (for example, the handwriting is located in a position corresponding to a signature field), it is determined that the document has been completed, and a new handwriting file is opened. However, the disclosure is not limited to thereto.

In an embodiment of the disclosure, the processing unit 128 also stores the document image and the document file that is created by integrating a document handwriting file with the original document file after the document grouping file has existed for a long time (for example, one year). Accordingly, the storage space of the electronic device 120 is saved.

In view of the foregoing, the electronic device and the handwriting board system according to the disclosure obtain and recognize the document image such that the corresponding document handwriting file and the original document file are automatically recognized. Accordingly, in terms of storage of digital documents, the document image, the document handwriting file and the original document file are no longer simply stored; instead, the connection among the document image, the document handwriting file and the original document file is enhanced by the document grouping file, thereby improving the efficiency of managing documents.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a communication unit, receiving at least one handwriting file;
a storage unit, storing at least one original file;
an image obtaining unit, obtaining a document image, wherein the handwriting file and the original file comprises a document handwriting file and an original document file that correspond to the document image respectively; and
a processing unit, connected to the communication unit, the storage unit and the image obtaining unit, wherein the processing unit recognizes a content of the document image and integrates the document image, the document handwriting file and the original document file into a document grouping file according to the content of the document image.

2. The electronic device of claim 1, wherein the processing unit recognizes a handwriting image in the document image corresponding to the handwriting, obtains the corresponding document handwriting file according to the handwriting image and further compares the document handwriting file with the document image to obtain the corresponding original document file according to the difference.

3. The electronic device of claim 1, wherein the processing unit further compares the handwriting image with the handwriting file by at least one of single area comparison, partial area comparison and complete area comparison to obtain a document handwriting file corresponding to the handwriting image.

4. The electronic device of claim 2, wherein the processing unit recognizes the handwriting in the document image according to a handwriting feature in the document image.

5. The electronic device of claim 4, wherein the handwriting feature comprises at least one of an ink trace, an ink vector, a position of handwriting, distribution of handwriting, color of handwriting and thickness of handwriting.

6. The electronic device of claim 2, wherein the document image and the handwriting file comprise a file feature each, and the processing unit compares the file features of the document image and the handwriting file to obtain the document handwriting file corresponding to the document image.

7. The electronic device of claim 6, wherein the file feature includes at least one of a user name, a position where a file is created and time when the file is created.

8. The electronic device of claim 1, wherein the processing unit recognizes and removes handwriting from the document image to obtain an original file image, and wherein the processing unit further obtains the corresponding original document file according to the original file image and compares the original document file and the document image to obtain the corresponding document handwriting file according to the difference.

9. The electronic device of claim 1, wherein the processing unit further receives a selection instruction to select the handwriting file and the original document file, wherein the processing unit integrates the handwriting file and the original document file into a document file, and wherein the processing unit determines whether contents of the document image and the document file are consistent to integrate the document image, the handwriting file and the original document file that are all consistent into the document grouping file.

10. The electronic device of claim 1, wherein the document image corresponds to the original document file and the document handwriting file.

11. The electronic device of claim 1, wherein the document handwriting file belongs to a file group including a plurality of handwriting files, and the processing unit integrates the document image, the original document file and the file group into the document grouping file.

12. The electronic device of claim 11, wherein the processing unit determines the sequence of the document handwriting file in the handwriting files according to the writing time of the handwriting files, generates a plurality of corresponding document files according to the original document file and the handwriting files, integrates the handwriting files and the corresponding document files into the document grouping file respectively according to the writing time and the sequence of the document handwriting file, and wherein the processing unit integrates the document image, the original document file, the document files and the file group into the document grouping file.

13. The electronic device of claim 11, wherein the original document file comprises a plurality of pages, and the document image comprises an image of at least one page of the corresponding original document file, wherein the processing unit recognizes a handwriting image of the document image corresponding to the document image, and obtains the document handwriting file in the handwriting files corresponding to the handwriting image according to the handwriting image, wherein the processing unit determines the sequence of the document handwriting file in the handwriting files according to writing time of the handwriting files, wherein the processing unit generates a document file of a plurality of pages corresponding to the original document file according to a plurality of pages of the original document file, the writing time of the handwriting files and the sequence of the document handwriting file in the handwriting files, and wherein the processing unit integrates the document image, the original document image, the document files and the file group into the document grouping file.
